(19) United States
(12) Patent Application Publication
(10) Pub. No.: US 2007/0046469 A1
(43) Pub. Date: Mar. 1, 2007

(54) Electronic Deactivation Device for RFID Surveillance and Storage

(76) Inventors: Mark Pempsell, Bedford, TX (US); Ryan Corley, Austin, TX (US)

Correspondence Address: BAKER BOTTS L.L.P., 2001 ROSS AVENUE, SUITE 600, DALLAS, TX, 75201-2980, US

(21) Appl. No.: 11/466,316

(22) Filed: Aug. 22, 2006

Related U.S. Application Data
(60) Provisional application No. 60/713,945, filed on Sep. 1, 2005.

(51) Int. Cl. G08B 13/14

(52) U.S. Cl. 340/572.1

(57) ABSTRACT

In accordance with the teachings of the present invention, an electronic deactivation device for RFID surveillance and storage is provided. In a particular embodiment, a deactivateable radio frequency identification device includes a capacitor and a passive component coupled with a RFID circuit, wherein the capacitor is operable to be disabled upon receipt of a signal of sufficient magnetic amplitude, and wherein disabling the capacitor disables the circuit. In another embodiment, a deactivateable radio frequency identification device includes a capacitor and an active component coupled with a RFID circuit, wherein the capacitor is operable to be disabled upon receipt of a signal of sufficient magnetic amplitude, and wherein disabling the capacitor disables the circuit.

### RELATED APPLICATION

This application claims the benefit of U.S. Provisional Application Ser. No. 60/713,945 filed Sep. 1, 2005.

### TECHNICAL FIELD OF THE INVENTION

The present invention relates generally to radio frequency identification devices and, more particularly, to an electronic deactivation device for RFID surveillance and storage.

### BACKGROUND OF THE INVENTION

The problem of protecting merchandise and the like against theft from retail stores has been the subject of numerous technical solutions. Among these, a tag or marker may be secured to an article to be protected. The tag responds to an interrogation signal from transmitting apparatus situated either at the exit door of the premises to be protected, or at the aisle way adjacent to the cashier or check out station. A receiving coil on the opposite side of the exit or aisle way from the transmitting apparatus, receiving a signal produced by the tag in response to the interrogation signal the presence of the response signal indicates the tag has not been removed or deactivated by the cashier, and that the article bearing it may not have been paid for or properly checked out.

There is a rising use of the radio frequency identification (“RFID”) devices due in part to retail outlets dictating to their suppliers the requirement of such devices. When such a device is specified to the supplier, this is known as “source tagging.” By tagging inventory with an RFID tag, the retailer may be able to precisely track the inventory from the receiving dock, to the display area, completely through to the point of sale and the electronic article surveillance (“EAS”) interrogation gates.

Radio frequency identification devices or RFID tagging exist in numerous systems for the identification and tracking of inventory, raw materials, materials in manufacturing, or other items in a variety of locations, such as manufacturing facilities and the like. Accurate and inexpensive locating, tracking, and inventorying of the physical location of items such as parts, goods, and materials is a necessity for many operations, such as manufacturing and warehousing, for a number of reasons. One such application includes the desire to quickly determine the physical location of a part in the manufacturing process, to determine if a part is present in inventory or storage, to determine quantity of an item on hand, tracking the progress of an item in manufacturing, and/or many other such functions.

Several different types of RFID tags have been disclosed in literature and are in use. In one type, the apparatus is a passive RFID tag material tracking system capable of real-time location and identification of thousands of items in production and storage areas. Passive RFID tags are tracked by remote sensing antennas placed in locations to be monitored or scanning interrogators with several multiplexed antenna inputs are attached to sensing antennas and a computer which in turn communicates with interrogators thereby determining exact item location and quantity.

A second type of RFID tagging comes in the form of externally activated or source active tags. The above mentioned devices are in an active state of data stream transmitting. In the active RFID scheme, the identifying device containing encoded information is placed on or in the goods, or other items to be identified by an RFID reader. The encoded information is read by the reader with no user data entry generally required. The information encoded on the RFID tag is then typically passed to a processing medium for decoding. The content of the encoded information may consist of, but is not limited to, data on manufacturing tractability, inventory control, purchase price, and, in some cases, the date of purchase.

Electronic article security system and in particular the use of the RFID tag discussed above have been shown to be very effective in inventory control and unauthorized removal of articles, particularly at the point of sale.

There is a growing concern among both advocacy groups and consumers in regard to invasion of privacy. It is a well-founded concern. When the RFID tag is activated, the item may stay activated past the point of sale and continue to transmit the encoded data stream while the item resides at the consumer's place of residence. In this situation, any person or agency that has in their possession the correct decoder, may be able to scan a consumer's residence or business, thereby obtaining personal information on the person, which may include purchasing habits and/or trends.

### SUMMARY OF THE INVENTION

The present invention relates to the deactivation of RFID tags by integrating a custom formulated tape with dielectric constants coupled to and in close proximity to the transmission device of the RFID transmitter and utilizing existing EAS technology and/or custom electromagnetic devices. It is the purpose of this invention to disable said tag by means of disabling the capacitor trunk.

Particular embodiments of the present invention provide a means of disabling EAS tags capable of producing identifying signal characteristics or data bits. The transmitter signal is identified by a device which is composed of a circuit containing a capacitor and inductor or coil. When connected in conjunction with existing RFID circuitry, the tag responds by emitting a signal or data stream that is detected by a receiver. In particular embodiments, the RFID transmitters operate in the 50 kHz to 10 MHz range. Particular embodiments of the present invention may use a formulated tape with dielectric constants that can be custom manufactured to match customer specifications. When a signal of sufficient magnetic amplitude is presented to this device, such as seen in retail outlets for deactivating EAS tags, the capacitor in the tagged item will be disabled, thereby permanently disabling the RFID tag. The procedure of disabling the capacitor may be present at the point of input or output of said RFID tag.

The procedure examined in the previous statements for disarmament of RFID article surveillance and tracking systems will provide the means to the manufacturing industry and the retailers in regard to the matter of invasion of privacy issues.

Other technical advantages of the present invention may be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and features and advantages thereof, reference is now made to the following description, taken in conjunction with the accompanying drawings, in which:

FIG. 1 illustrates a perspective view of a capacitor in accordance with a particular embodiment of the present invention;

FIG. 2 illustrates an input circuit of an RFID tag in accordance with a particular embodiment of the present invention; and

FIG. 3 illustrates a transmission antenna for a RFID tag in accordance with a particular embodiment of the present invention.

### DETAILED DESCRIPTION OF THE INVENTION

In the following detailed description of the preferred embodiment, reference is made to the accompanying drawings which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical mechanical, electrical and structural changes may be made without departing from the spirit or scope of the invention. To avoid detail not necessary to enable those skilled in the art to practice the invention, the description may omit certain information known to those skilled in the art. The following detailed description is, therefore, not to be taken in a limited sense, and the scope of the present invention is defined only by the appended claims.

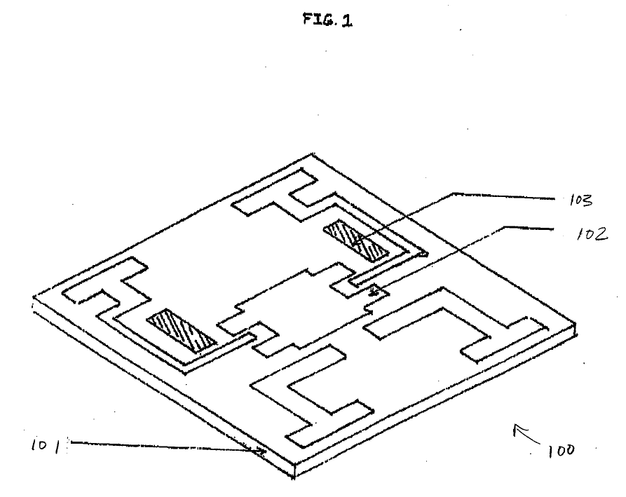

FIG. 1 illustrates a perspective view of a capacitor device 100, in accordance with a particular embodiment of the present invention. As shown in FIG. 1, capacitor device 100 comprises a capacitor substrate 101, which may consist of ceramic or tape. A capacitor 102 is bonded to the substrate 101. Located within the parameters of substrate 101, an active or passive component 103 may be encapsulated along with the capacitor 102 onto the substrate 1, thereby forming a circuit. When connected in conjunction with existing RFID circuitry, the tag responds by emitting a signal or data stream that is detected by a receiver. In particular embodiments of the present, RFID transmitters operate in the 50 kHz to 10 MHz range. Particular embodiments of the present invention may use a formulated tape with dielectric constants that can be custom manufactured to desired specifications.

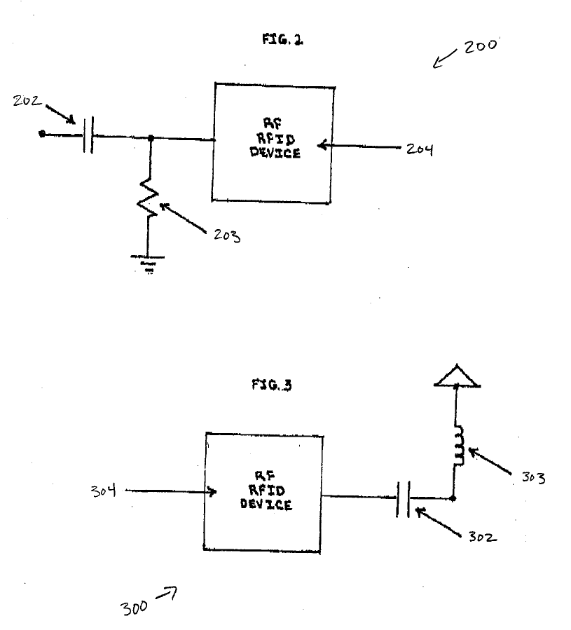

FIG. 2 illustrates a RC circuit 200 in accordance with a particular embodiment of the present invention. As shown in FIG. 2, RC circuit 200 comprises a capacitor 202 and a passive component 203, such as a resistor, coupled to a RFID device 204.

FIG. 3 illustrates a LC circuit 300 in accordance with a particular embodiment of the present invention. As shown in FIG. 3, LC circuit 300 comprises a capacitor 302 and an active component 303, such as an inductor, coupled to a RFID device 304.

When a magnetic or electromagnetic signal have sufficient magnetic amplitude is presented to circuits 100 (FIG. 2), 200 (FIG. 2) or 300 (FIG. 3), the capacitor in the circuit may be disabled, thereby permanently disabling the circuit. The procedure of disabling the capacitor may be present at the point of input or output of said RFID tag.

Numerous systems exist for tracking of inventory, raw material and the performance of material in various locations, such as manufacturing facilities, inventory control, and the like. Accurate and inexpensive locating, tracking, and inventory location of the items, such as parts, goods and materials, may be necessary for smooth and accurate manufacturing and warehousing.

Electronic article surveillance (EAS) system technology is used to identify articles as they pass through a gated area in a store. This identification is used to alert someone that unauthorized removal of items is being attempted. EAS systems may be useful anywhere there is an opportunity for theft of items at any size, EAS technologies are being produced to reduce shoplifting, help increase sales, lower labor costs speed inventory, improve stockroom logistics and increase security at manufacturing and distribution facilities.

The Radio Frequency (“RF”) or RFID device systems are widely used in the United States. A RF system tag or label basically is a miniature disposable electronic circuit and antenna attached to a product and responds to a specific frequency emitted by a transmitter antenna. The RF tag response signal may be processed and trigger an alarm when it matches specific criteria.

RFID devices are gaining popularity in the global retail and industrial industries. A RFID system tag is a miniature electronics circuit that transmits a data bit transmission of readable information. These devices are offered in both the passive and active state, with the industry moving more towards using active state RFID tags. These devices may offered in a variety of circuitry and packaging. However, the same conditions must accrue for the expectable response from the device. For example, the device must contain an external or internal power source, a processor and a transmitter. This invention utilizes a technology that addresses the external and internal power source along with the transmitter.

Each of these RF systems operate on different principles and are not always compatible, and have specific benefits and disadvantages. The Consumer Product Manufacturers' Association is encouraging a tower centric RF approach that can read multiple tag technologies rather then the tag-centric models that exist today. Particular embodiments of the present invention may be capable of incorporating existing RF, RFID, and EAS technologies, and may also include future tower-centric technologies currently under development.

Although particular embodiments of the method and apparatus of the present invention have been illustrated in the accompanying drawings and described in the foregoing detailed description, it will be understood that the invention is not limited to the embodiments disclosed, but is capable of numerous rearrangements, modifications, and substitutions without departing from the spirit of the invention as set forth and defined by the following claims.

What is claimed is:

1. A deactivateable radio frequency identification device, comprising:
a capacitor and a passive component coupled with a RFID circuit;
wherein the capacitor is operable to be disabled upon receipt of a signal of sufficient magnetic amplitude; and
wherein disabling the capacitor disables the circuit.

2. The device of claim 1, wherein the passive component is a resistor.

3. The device of claim 1, wherein the RFID circuit is operable to transmit in the 50 kHz to 10 MHz range.

4. A deactivateable radio frequency identification device, comprising:
a capacitor and a active component coupled with a RFID circuit;
wherein the capacitor is operable to be disabled upon receipt of a signal of sufficient magnetic amplitude; and
wherein disabling the capacitor disables the circuit.

5. The device of claim 4, wherein the active component is an inductor.

6. The device of claim 4, wherein the active component is a coil.

7. The device of claim 4, wherein the RFID circuit is operable to transmit in the 50 kHz to 10 MHz range.

8. A method of constructing a deactivateable radio frequency identification device, comprising:
coupling a capacitor is an active component; and
coupling the capacitor and active component with a RFID circuit;
wherein the capacitor is operable to be disabled upon receipt of a signal of sufficient magnetic amplitude; and
wherein the capacitor is coupled to the active component and RFID circuit such that disabling the capacitor disables the circuit.

9. The method of claim 8, wherein the active component is an inductor.

10. The method of claim 8, wherein the active component is a coil.

11. The method of claim 8, wherein the RFID circuit is operable to transmit in the 50 kHz to 10 MHz range.
